(19) United States
(12) Patent Application Publication
(10) Pub. No.: US 2010/0043970 A1
(43) Pub. Date: Feb. 25, 2010

(54) METHOD OF PRODUCING A WOOD BASED PRODUCT

(75) Inventors: Farideh Khabbaz, Nacka (SE); Per Anders Eriksson, Nacka (SE); Joanna Fare, Huddinge (SE); Anna Kristina Furberg, Sundbyberg (SE)

Correspondence Address: KENYON & KENYON LLP, ONE BROADWAY, NEW YORK, NY, 10004, US

(73) Assignee: AKZO NOBEL COATING INTERNATIONAL B.V., Arnhem (NL)

(21) Appl. No.: 12/520,371

(22) PCT Filed: Dec. 7, 2007
(86) PCT No.: PCT/SE07/50950

§ 371 Date: Jul. 22, 2009

Related U.S. Application Data
(60) Provisional application No. 60/876,367, filed on Dec. 21, 2006.

(30) Foreign Application Priority Data
Dec. 20, 2006 (EP) 06126692.0

(51) Int. Cl. B29C 65/52

(52) U.S. Cl. 156/326

(57) ABSTRACT

The present invention relates to a method of producing a wood based product comprising applying a water-based adhesive composition comprising non-gelatinised starch, the composition further comprises from 0.1 to 50 weight % of one or more polymers (P) containing an amine group or an amide group, onto one or more pieces of a wood-based material and joining the one or more pieces with one or more further pieces of a wood based material.

### INTRODUCTION

Formaldehyde based resins such as phenol-formaldehyde resin, melamine-formaldehyde resin and urea-formaldehyde resin are widely used as binders in the production of wood based products. Examples of such wood based products are composite products comprising layers glued together such as plywood, laminated flooring products and veneered products used in, e.g., furniture. Further examples are board products such as particle-, chip- and fibreboards wherein wood chips and/or fibres, together with a binder, are pressed to form a board.

Upon curing a formaldehyde based resin, formaldehyde may be released both during the manufacture of the wood based product and also later during use of the product. Formaldehyde emission to indoor air is a major concern since many years for health reasons.

There is an increasing demand for formaldehyde-free wood adhesives which give sufficient bond strength and overall end-product quality making them suitable as alternatives to prior art adhesives containing formaldehyde based resins.

Water resistance and bond strength are generally important properties reflecting quality for the wood based products. Generally there exist specific quality parameters required for meeting an established standard for a specific end-product. For example, a particle board needs to meet certain standards in terms of, e.g., internal bonding, thickness swelling and water absorption, while a laminated flooring product needs to meet certain standards in terms of, e.g., delamination and fiber tear.

As an alternative to adhesive compositions comprising formaldehyde based resins adhesives based on polymer dispersions of e.g. polyvinyl acetate is available. However, when making compression-moulded products by glueing together layers of veneers and pressing the structure into a certain shape it is important to minimise the so called “spring back” of the glued structure when it is released from the mould. Polyvinyl acetate based adhesives generally give bad results in terms of spring back.

It is also important that a compression-moulded product substantially keeps its shape during use, i.e., when subjected to a load. This property can be measured by a so called “fatigue test”, used in e.g. for furniture products, where a compression-moulded product is subjected to a large number of cycles of a load.

As an alternative to formaldehyde based resins in wood adhesive compositions starch based adhesives have been proposed. Imam et al., “Wood Adhesive from Crosslinked Poly(vinyl alcohol) and Partially Gelatinized Starch: Preparation and Properties”, Starch/Stärke 51 (1999) Nr. 6, S. 225-229, discloses an adhesive composition comprising starch and polyvinyl alcohol, the composition further comprising a melamine resin. U.S. Pat. No. 2,051,025, U.S. Pat. No. 2,102,937, U.S. Pat. No. 3,487,033, U.S. Pat. No. 3,355,307 disclose starch based adhesives used for making corrugated paperboard. WO 03/069061 A1 discloses a starch based adhesive used in making a paperboard product.

There is still a need for alternative methods of gluing wood based materials using starch based adhesive compositions.

Accordingly, the present invention provides a method of gluing wood based materials by using an adhesive composition which is based on starch giving excellent gluing quality.

### The Invention

The present invention provides a method of producing a wood based product comprising applying a water-based adhesive composition comprising non-gelatinised starch, the composition further comprises from about 0.1 to about 50 weight % of one or more polymers (P) containing an amine group or an amide group, onto one or more pieces of a wood-based material and joining the one or more pieces with one or more further pieces of a material, preferably wood based material.

By non-gelatinised starch is herein meant such a starch which in an aqueous phase has only been subjected to temperatures of less than 50° C., suitably less than about 45° C., preferably less than about 40° C., and is therefore not gelatinised.

The weight ratio starch to polymers (P) in the adhesive composition used in the method suitably from about from about 1:2 to about 25:1, preferably from about 1:1 to about 15:1, most preferably from about 3:1 to about 8:1.

The adhesive composition used in the method suitably comprises from about 10 to about 50 weight % of starch, preferably from about 15 to about 45 weight %, more preferably from about 20 to about 40 weight %, most preferably from about 25 to about 35 weight %.

The adhesive composition used in the method suitably comprises from about 1 to about 40 weight % of the one or more polymers (P), preferably from about 1.5 to about 25 weight %, most preferably from about 2 to about 15 weight %.

The solids content in the adhesive composition used in the method is suitably from about 20 to about 70 weight %, preferably from about 35 to about 60 weight %, most preferably from about 40 to about 50 weight %.

By “solids content” of the adhesive composition used in the method is herein meant the non-water part of the adhesive composition.

Examples of suitable starches in the adhesive composition used in the method are native starches and modified starches made from, e.g., potato, corn, wheat, rice, peas etc., such as: acetylated degraded starch, alkyl succinic acid modified starch, oxidated starch, hydroxypropylated starch, cationic starch, amylopectin starch, high amylose acetylated starch, tapioka starch, native potato starch, native corn starch, native wheat starch, native rice starch, and, native pea starch.

The one or more polymers (P) in the adhesive composition used in the method suitably comprise monomer units containing an amine or an amide group. Suitably, from about 5 to about 100% of the monomer units in the one or more polymers (P) contain an amine or an amide group, preferably from about 25 to about 100%, more preferably from about 50 to about 100%, even more preferably from about 90 to about 100%. Most preferably all of the monomer units in the one or more polymers (P) contain an amine or an amide group.

The one or more polymers (P) suitably contain a primary amine group or an amide group. The one or more polymers (P) preferably comprise one or more of polyvinyl amine, poly(vinylalcohol-co-vinyl amine), poly(vinylalcohol-co-vinylformamide), polyallylamine, polyethylene imine, polyamidoamine and polyvinyl formamide. More preferably the one or more polymers (P) comprise one or more of polyvinyl amine and poly(vinylalcohol-co-vinylamine). Most preferably polymer (P) is polyvinyl amine.

In one embodiment, the one or more polymers (P) suitably belong to the group of vinyl polymers. In such a case, the one or more polymers (P) preferably comprise one or more of polyvinyl amine, poly(vinylalcohol-co-vinylamine), poly(vinylalcohol-co-vinylformamide), polyallyl amine, and polyvinyl formamide. More preferably the one or more vinyl polymers (P) contain a primary amine group. Most preferably vinyl polymer (P) is polyvinyl amine.

In one embodiment, the one or more polymers (P) suitably contain primary amino groups or pendant amide groups. The one or more polymers (P) preferably comprise one or more of polyvinyl amine, poly(vinylalcohol-co-vinyl amine), poly(vinylalcohol-co-vinylformamide), polyallylamine, polyethylene imine and polyvinyl formamide. Most preferably polymer (P) is polyvinyl amine or polyethylene imine.

Polyvinyl amine is usually made by hydrolysing polyvinyl formamide to a certain degree. By “polyvinyl amine” is herein meant a polyvinyl amine wherein the mole ratio of amine groups to formamide groups is from 5:95 to 100:0. If the mole ratio of amine groups to formamide groups is less than 5:95 the polymer is defined as a polyvinyl formamide. The mole ratio of amine groups to formamide groups in the polyvinyl amine is preferably from about 10:90 to about 100:0, more preferably from about 50:50 to about 100:0, most preferably from about 80:20 to about 100:0.

Poly(vinyl alcohol-co-vinyl amine) is usually made by co-polymerising vinyl acetate and vinyl formamide followed by hydrolysis which gives a co-polymer having vinyl alcohol and vinyl amine units. There may also be remaining formamide groups in the co-polymer and also remaining acetate groups. The mole ratio of amine groups to formamide groups in the poly(vinyl alcohol-co-vinyl amine) is from 5:95 to 100:0. If the number ratio of amine groups to formamide groups is less than 5:95 the polymer is defined as a poly(vinyl alcohol-co-vinyl formamide). The mole ratio of hydroxyl groups to acetate groups in the poly(vinyl alcohol-co-vinyl amine) or poly(vinyl alcohol-co-vinyl amide) is suitably from about 25:75 to 100:0, preferably from about 75:25 to 100:0. The mole ratio of amine and formamide groups to hydroxyl and acetate groups in the poly(vinyl alcohol-co-vinyl formamine) or poly(vinyl alcohol-co-vinyl formamide) is suitably from about 3:97 to about 100:0, preferably from about 10:90 to about 100:0, most preferably from about 25:75 to about 100:0.

The one or more polymers (P) have suitably a weight average molecular weight of from about 1.000 to about 1.000.000 g/mol, preferably from about 10.000 to about 800.000 g/mol, more preferably from about 20.000 to about 600.000 g/mol, most preferably from about 50.000 to about 500.000 g/mol.

The viscosity (Brookfield, 12 rpm, spindle 4, at 20° C.) of the adhesive composition is suitably lower than 100.000 mPa*s, preferably from about 1.000 to about 50.000 mPa*s, most preferably from about 5.000 to about 20.000 mPa*s.

The adhesive composition used in the method may also be combined with a cross-linker shortly before use. Suitable cross-linkers are those which are reactive to amino and/or hydroxyl groups. Examples of crosslinkers are: isocyanates, monomers or polymers containing adipic acid, melamine formaldehyde resin, urea formaldehyde resin, melamine salts, aldehydes such as glutaraldehyde, glyoxal, and polymeric aldehydes such as dialdehyde starches, and, complexing agents such a zirconium salts. It may be added to any of the two components of the adhesive composition. If used, the amount of the cross-linker in a component of the adhesive composition is suitably up to about 30 weight %, or from about 0.1 to about 30 weight %.

The adhesive composition used in the method suitably further comprises one or more polymers (P1) containing acetoacetoxy groups. The content of acetoacetoxy groups in the one or more polymers (P) is suitably from about 0.05 to about 15 mole%, preferably from about 1 to about 10 mole %. The one or more polymers (P1) preferably comprise acetoacetylated polyvinyl alcohol (AAPVA).

The one or more polymers (P1) have suitably a weight average molecular weight of from about 1.000 to about 5.000.000 g/mol, preferably from about 10.000 to about 2000.000 g/mol.

The one or more components of the adhesive composition used in the method comprising starch, polymer (P) and polymer (P1) respectively may further comprise additives such as viscosity adjusting agents and fillers such as kaolin, wheat meal, soy meal, walnut shell meal, or other known to be suitable for use in wood adhesive formulations.

The adhesive composition used in the method may also comprise inorganic- or organic salts which may have originated from a solution of the one or more polymers (P) or (P1) used when making the starch based adhesive composition. A part of the one or more polymers (P) and/or (P1) may be ionically charged, preferably cationically charged. The amount of negative counter-ions of the salts in the adhesive composition can be from 0 to about 10 weight %, or from about 0.1 to about 5 weight %, or from about 0.2 to about 1 weight %.

The adhesive composition used in the method may also comprise a polymer or copolymer (P2) of one or more ethylenically unsaturated monomers, different from the one or more polymers (P). The polymer or copolymer (P2) does suitably not contain any acetoacetoxy groups. The content of polymer or copolymer (P2) in the adhesive composition is suitably from about 1 to about 50 weight %, preferably from about 3 to about 40 weight %, most preferably from about 5 to about 30 weight %.

A dispersion of the polymer or copolymer (P2) may, besides being mixed-in with starch and the one or more polymers (P), forming the adhesive composition also be used as a separate component in combination with the adhesive composition, forming a combination of the adhesive composition according to the invention and the dispersion of the polymer or copolymer (P2) of one or more unsaturated monomers. This combination is then used in the method of the invention. In this combination, the amount of adhesive composition is suitably from about 25 to about 99 weight %, preferably from about 40 to about 90 weight %, most preferably from about 50 to about 85 weight %, based on the total weight of the combination. The amount of dispersion of polymer or copolymer (P2) is suitably from about 1 to about 75 weight %, preferably from about 10 to about 60 weight %, most preferably from about 20 to about 50 weight %, based on the total weight of the combination. The content of polymer or copolymer (P2) in its dispersion is suitably from about 10 to about 90 weight %, preferably from about 25 to about 75 weight %.

Examples of suitable polymers or copolymers of one or more ethylenically unsaturated monomers are vinyl ester homopolymers such as polyvinyl acetate, copolymers of vinylesters such as ethylene-vinyl acetate copolymer (EVA) or copolymers of vinylacetate with one or more acrylic monomers such as methylmethacrylate or butylacrylate, styrene-butadiene rubber (SBR), and polyacrylates.

Generally, the inclusion of polymers or copolymers of one or more ethylenically unsaturated monomers, of the types listed above, in the starch based adhesive composition used in the method, or in combination with the starch based adhesive composition, may improve the bonding characteristics, such as fiber tear of a veneered or laminated product.

In one embodiment, the method suitably comprises applying the adhesive composition onto a piece of wood based material, contacting the surface with applied adhesive composition with a surface of another piece of wood based material, thereby joining the pieces through the formation of an adhesive joint between the pieces.

In one embodiment of the method the adhesive composition is dried after application and later activated by adding an aqueous composition.

In one embodiment, when manufacturing laminated products, the method suitably comprises application of the adhesive composition onto a surface so that the glue joint will comprise an originally applied amount of from about 0.1 to about 500 g/m². The applied amount depends on the product to be produced: for compression moulded veneers it is preferably from about 50 to about 200 g/m², for laminated flooring material it is preferably from about 100 to about 160 g/m², and for laminated beams it is preferably from about 180 to about 500 g/m². The suitable upper limit also depends on which type of wood based material that is applied with the solution. The adhesive composition may be applied on one or both of the surfaces to be joined. If applied on both surfaces, the sum of the amounts applied on each surface will correspond to the preferred amounts for the whole glue joint specified.

When making compression-moulded veneers, the method suitably comprises the joining of more than two pieces of wood based materials, preferably from 2 to 15.

By wood-based materials is herein, beside solid wood, also included wooden materials such as fibre-, chip-, and particleboard materials. The surfaces to be joined may be of the same or different type of wood based material.

The wood based material can be any type and form of wood based material such as chips, fibres, sheets, laminas, veneers, pieces etc.

In one embodiment, the method comprises gluing pieces of wood based materials wherein the pieces of wood based material are wood chips, in which the term “wood chips” herein includes chips, shavings, flakes, sawdust particles and any similar finely divided wood based material. In this case the wood based product is a composite product such as a chip-, particle- or fibre board, or an oriented strand board.

The moisture content of the wood chips to be used is suitably from about 0 to about 20 weight %, preferably from about 1 to about 10 weight %, more preferably from about 1.5 to about 5 weight %.

The weight ratio wood chips to adhesive composition used in the method, calculated as dry weight, is suitably from about 100:1 to about 1:1, preferably from about 50:1 to about 2:1, more preferably from about 30:1 to about 2.5:1, most preferably from about 15:1 to about 3:1.

The moisture content of the mixture of wood chips and adhesive composition used in the method at the beginning of the pressing is suitably from about 3 to about 25 weight %, preferably from about 5 to about 20 weight %, more preferably from about 6 to about 18 weight %, most preferably from about 7 to about 15 weight %.

The application of the adhesive composition is preferably followed by pressing. The pressing suitably takes place at an elevated temperature. The pressing temperature depends on which wood based product intended to be manufactured but can suitably be from about 0 to about 250 ° C. and preferably from about 70 to about 200° C.

For laminated or veneered products, the pressing temperature, when no cross-linker has been added to the adhesive composition, is suitably from about 0° C. to about 200° C., preferably from about 20 to about 150° C., even more preferably from about 50 to about 130° C., most preferably from about 70 to about 130° C. When a cross-linker has been added to the adhesive composition, the pressing temperature may sometimes be decreased depending on the efficiency of the cross-linker.

For particle-, chip-, and fibreboard products, the pressing temperature is preferably from about 100 to about 225° C., most preferably from about 150 to about 200° C. For laminated products, such as plywood, laminated flooring or veneered flooring products, the pressing temperature is preferably from about 70 to about 175 ° C., most preferably from about 90 to about 160° C.

The pressing time and pressing temperature are linked so that lower pressing temperatures generally require longer pressing times. The wood based product to be produced does also determine suitable pressing temperatures and pressing times. The pressing time is suitably at least about 10 s, also suitably from about 10 s to about 60 minutes, preferably at least about 30 s, also preferably from about 30 s to about 30 minutes, most preferably at least about 1 minute, also preferably from about 1 to about 15 minutes.

In one embodiment, the pieces of wood based material are sheets or lamellas. In this case, the wood based product is suitably a laminated flooring material, veneered flooring, a veneered furniture material, a wall panel, a roofing panel, plywood or a laminated beam.

The wood based product of the invention is suitably a laminated or veneered material, such as laminated flooring, veneered flooring, a veneered furniture material, plywood, a wall panel, a roofing panel, a laminated beam, or a composite product such as a particle board, fibre board, chip board or oriented strand board. Preferably, it is plywood, a veneered furniture material, veneered flooring, laminated flooring or a particle board.

The invention is further illustrated by means of the following non-limiting examples. Parts and percentages relate to parts by weight respectively percent by weight, unless otherwise stated.

### EXAMPLES

### Example 1

A starch based adhesive was made by mixing 65.5 g of an aqueous solution of about 7.5 weight % polyvinyl amine (Lupamin® 9095 from BASF), 5.7 g water and 32.4 g corn starch (C*Gum NC 03432 from Cerestar, 10% moisture content), at room temperature (25° C.). The number ratio of amine groups to formamide groups in the polyvinyl amine was more than 90:10. The weight average molecular weight of the polyvinyl amine was 340.000 g/mol. The viscosity of the composition was measured to 12.000 mPa*s at 20° C. (Brookfield, 12 rpm, spindle 4).

### Example 2

A starch based adhesive was made by mixing 75 parts by weight of the adhesive composition according to Example 1 with 25 parts by weight of an acrylate/PvAc dispersion having a polymer content of 50 weight %.

### Example 3

Veneered products were manufactured by gluing a top veneer of 0.6 mm beech onto one side of 15×15 cm particle boards. The boards were applied with 3.7 g of adhesive compositions according to Examples 1 and 2 and the veneers were directly pressed onto the boards during 1 minute at 90 and 130° C. respectively. The fiber tear (chisel) was tested.

TABLE 1
(Pressing time 1 minute)

| | Fiber tear (%) | |
|---|---|---|
| Pressing | Example 1 | Example 2 |

| temperature | Warm | Cold | Warm | Cold |
|---|---|---|---|---|
| 90° C. | 0 | 0 | 0-5 | 10 |
| 130° C. | 90-100 | 100 | 90 | 100 |

The tests were repeated but using a pressing time of 10 minutes at 90° C. and 5 minutes at 130° C. respectively instead. The results are shown in table 2.

TABLE 2
(Pressing time 10 minutes)

| | | Fiber tear (%) | | | |
|---|---|---|---|---|---|
| Pressing | Pressing | Example 1 | | Example 2 | |
| temperature | time | Warm | Cold | Warm | Cold |
| 90° C. | 10 minutes | 10 | 10 | 80-90 | 100 |
| 130° C. | 5 minutes | 90-100 | 100 | 90-100 | 100 |

### Example 4

Two products were made each of 13 veneers of beech glued together by using an adhesive composition according to Example 1 and 2 respectively in combination with compression-moulding at 120° C. for 8 minutes. The spring-back was determined for both products. The spring-back was very low for both products.

### Example 5

A particle board was manufactured by mixing 864 g wood chips, having a moisture content of 1.7 weight %, with 216 g of an adhesive composition made by mixing, at room temperature, 131 g of an aqueous solution of about 7.5 weight % polyvinyl amine (Lupamin® 9095 from BASF), 75 g corn starch (C*Gum NC 03432 from Cerestar, 10% moisture content) and 10 g water. The mixing was made at room temperature (22° C.) for 5 minutes. The chips mixture was formed into a sheet of 30×30 cm and pressed at 189° C. for three minutes into a board of 16 mm thickness. The sequence of pressure was 150 kg/cm² during 30 s, 40 kg/cm² during 2 min and 2 kg/cm² during the last 30 s. The tensile strength (internal bond, IB) was measured by gluing pieces of 5×5 cm onto two metal blocks and tearing them apart. Thickness swelling (TSW) and water absorption (ABS) were also measured. Thickness swelling was measured by determining the degree of swelling after a piece of 5×5 cm had been immersed in water (20° C., 24 hrs). Water absorption was measured by determining the weight increase after a piece of 5×5 cm had been immersed in water (20° C., 24 hrs).

The IB value was 690 kPa, TSW 53% and ABS (24 h) was 121%.

1. A method of producing a wood based product comprising applying an adhesive composition comprising non-gelatinised starch in an aqueous phase, the composition further comprising from about 0.1 to about 50 weight % of one or more polymers (P) containing an amine group or an amide group, onto one or more pieces of a wood based material, and joining the one or more pieces with one or more further pieces of a material.

2. The method according to claim 1, wherein the amount of starch in the adhesive composition is from about 15 to about 40 weight %.

3. The method according to claim 1, wherein the amount of the one or more polymers (P) in the adhesive composition is from about 2 to about 25 weight %.

4. The method according to claim 1, wherein the one or more polymers (P) belong to the group of polyvinyl amine, poly(vinylalcohol-co-vinyl amine), polyallylamine, polyethylene imine and polyvinyl formamide.

5. The method according to claim 4, wherein the polymer (P) is polyvinyl amine.

6. The method according to claim 1, wherein the adhesive composition further comprises one or more polymers (P1) containing acetoacetoxy groups.

7. The method according to claim 1, wherein the adhesive composition further comprises a polymer or copolymer (P2) of one or more ethylenically unsaturated monomers, different from the one or more polymers (P).

8. The method according to claim 7, wherein the polymer (P2) is a vinyl ester homopolymer or a vinyl ester copolymer.

9. The method according to claim 8, wherein the polymer (P2) is a copolymer of vinyl acetate with one or more acrylic monomers.

10. The method according to claim 1, comprising gluing pieces of wood based materials wherein the pieces of wood based material are sheets or lamellas.

11. The method according to claim 1, comprising gluing pieces of wood based materials wherein the pieces of wood based material are wood chips.

12. The method according to claim 1, wherein the wood based product is a laminated flooring material, veneered flooring material, a veneered furniture material, a wall panel, a roofing panel, plywod or a laminated beam.

13. The method Meted according to claim 1, wherein the wood based product is a chip-, particle- or fibre board or an oriented strand board.

14. A method of producing a wood based product comprising applying an adhesive composition onto one or more pieces of a wood based material, and joining the one or more pieces with one or more further pieces of a material, said adhesive composition comprising from about 15 to about 40 weight % of non-gelatinised starch in an aqueous phase, and further comprising from about 0.1 to about 50 weight % of one or more polymers (P) selected from the group consisting of polyvinyl amine, poly(vinylalcohol-co-vinyl amine), polyallylamine, polyethylene imine and polyvinyl formamide.

15. The method according to claim 14 wherein the polymer (P) is polyvinyl amine.

16. The method according to claim 14, wherein the polymer (P) has a weight average molecular weight of from about 1,000 to about 1,000,000 g/mol.

17. A method of producing plywood, a veneered furniture material, veneered flooring, laminated flooring or a particle board comprising applying an adhesive composition onto one or more pieces of a wood based material, and joining the one or more pieces with one or more further pieces of a material, said adhesive composition comprising from about 15 to about 40 weight % of non-gelatinised starch in an aqueous phase, and further comprising from about 0.1 to about 50 weight % of one or more polymers (P) selected from the group consisting of polyvinyl amine, poly(vinylalcohol-co-vinyl amine), polyallylamine, polyethylene imine and polyvinyl formamide.

18. The method according to claim 17 wherein the polymer (P) is polyvinyl amine.

19. The method according to claim 17, wherein the polymer (P) has a weight average molecular weight of from about 1,000 to about 1,000,000 g/mol.
